(19) United States
(12) Patent Application Publication
(10) Pub. No.: US 2011/0029405 A1
(43) Pub. Date: Feb. 3, 2011

(54) SYSTEMS AND METHODS FOR LINKING TO A VENDOR

(76) Inventors: Todd Cronin, Franklin, MA (US); Phil Sergi, Franklin, MA (US)

Correspondence Address: COOLEY LLP;ATTN: Patent Group, Suite 1100, 777 - 6th Street, NW, WASHINGTON, DC, 20001, US

(21) Appl. No.: 12/824,840

(22) Filed: Jun. 28, 2010

Related U.S. Application Data
(60) Provisional application No. 61/230,889, filed on Aug. 3, 2009.

(51) Int. Cl. G06Q 30/00; G06Q 99/00; G06F 17/30; G06F 15/16

(52) U.S. Cl. 705/26.41; 707/748; 709/203; 707/E17.044

(57) ABSTRACT

A method includes receiving from a client terminal an indication of a selection of an item, selecting a vendor from a plurality of vendors, and sending a redirect message to the client terminal. The selection of the item is in response to the receipt of the indication of selection. Each of the vendors is offering the item for sale. The redirect message includes a reference to a webpage associated with the vendor and the item. In some embodiments, the method includes ranking the plurality of vendors based on at least two factors associated with each vendor and then selecting the vendor based on the ranking.

### CROSS-REFERENCE TO RELATED APPLICATION

This application claims priority to U.S. Provisional Patent Application Ser. No. 61/230,889, filed on Aug. 3, 2009, and entitled “SYSTEMS AND METHODS FOR LINKING TO A VENDOR,” which is incorporated herein by reference in its entirety.

### BACKGROUND

The disclosed invention relates generally to searching for an item for sale and directly linking a user to an online vendor selling the item, including, for example, an online vendor that is selected based on a set of factors. Methods according to various embodiments are capable of, for example, directly linking a user to an online vendor based on the vendor's ranking.

Methods of online searching for an item for sale and identifying vendors selling the item are known. For example, online vendors offer application programming interface (“API”) programs to allow content aggregating websites to request the availability of items for sale. The content aggregating websites allow users to select a specific item for sale and returns a list of online vendors selling the item.

Known content aggregating websites, however, do not link the user to the original vendor in response to the user's selection of an item for sale. Rather, known content aggregating websites provide, on their own websites, a list of hyperlinks to vendor websites from which the user may select. By providing links to vendors on the content aggregating website, and not providing the original vendor's purchase page in response to the user's selection of an item for sale, the rate at which sales are made may be drastically reduced. In addition, known content aggregating websites do not take into account the level of commission rates paid by online vendors to the content aggregating websites when a sale is made. Thus, a need exists for directly linking a user, in response to the user's selection of an item for sale from a website, to the original vendor's purchase page.

### SUMMARY

In one embodiment, a method includes receiving from a client terminal an indication of a selection of an item, selecting a vendor from a plurality of vendors, and sending a redirect message to the client terminal. The selection of the item is in response to the receipt of the indication of a selection of an item. Each of the plurality of vendors is offering the item for sale. The redirect message includes a reference to a webpage associated with the vendor and the item.

In one embodiment, a method includes receiving an item selection from a user, identifying a vendor selling the item, and displaying the vendor's webpage to the user. The vendors selling the item are identified in real-time. In other words, the vendors are identified in response to the receipt of a user's selection of an item, such that changes to the item or to the vendors that occur prior to the user's selection are accounted for. For example, if one vendor no longer has the item for sale, such information will be taken into account when identifying and/or selecting a vendor. After the vendors are identified, a preferred vendor is selected from the list. In some embodiments, the highest ranked vendor is selected. In other embodiments, one of the highest ranked vendors is selected.

In some embodiments, a method of ranking vendors includes identifying the vendors selling the item selected by the user and ranking the vendors based on at least two of the vendor's conversion rate, the commission rate paid to the content aggregators by the vendors, item availability, reputation of the vendors, price, average purchase price, purchase options, delivery options, partner influence, historical analyses, purchase medium, service charges, promotional codes, time remaining until the item is no longer available, presale, and/or predetermined value.

In other embodiments, a computer-implemented method includes receiving a user's selection of an item for sale, identifying vendors that sell the item, selecting a vendor based on a set of factors, and displaying the vendor's purchase page in response to the user's selection.

### BRIEF DESCRIPTION OF THE DRAWINGS

FIG. 1 is a flow chart of a method for directly linking a user to a vendor selling an item selected by the user, according to an embodiment.

FIG. 2 is a block diagram of a system for directly linking a user to a vendor selling an item selected by the user, according to an embodiment.

FIG. 3 is a system block diagram of a system for locating an item for purchase via a communications network, according to an embodiment.

FIG. 4 is a block illustration of a webpage displaying an item for sale, according to an embodiment.

FIG. 5 is a schematic block diagram of a system for directly linking a user to a vendor selling an item selected by the user including message flows, according to an embodiment.

### DETAILED DESCRIPTION

One or more embodiments of methods disclosed herein can directly link a user to one of a group of online vendors selling an item selected by the user. In some embodiments, the process of selecting a vendor can be transparent to the user. Said differently, the user can select one or more items such as tickets to a concert, a sporting event, an athletic event, a play, an opera, a ballet, and/or other tickets and be provided with a webpage at which the item can be purchased without additional action (e.g., selecting a vendor) by the user. Further more, items can include physical items such as books, consumer electronics, and/or other items.

For example, a webpage displayed at a user's Internet browser can include an image or icon related to tickets for a concert. In other words, the image can be a link to a computer server that provides access to (e.g., an option to purchase) tickets to the concert. The user can select the image (e.g., click on the image using a computer mouse) to purchase tickets to the concert. The computer server receives a message (e.g., a hypertext markup language (“HTML”) GET request including a uniform resource identifier (“URI”) such as a uniform resource locator (“URL”)) indicating that the user clicked on the image. The computer server can interpret one or more parameters of the message to determine to which concert the message is related and, for example, at which website the image selected by the user is located.

In response to the message, the computer server (also referred to as a link server) can determine to which vendor from a group of vendors to direct (or redirect) the user. In other words, the computer server can receive the message and direct the user to a vendor (e.g., a vendor server, website or webpage) at which the user can purchase tickets. For example, the computer server can access a database including pricing, availability, user preferences, vendor preferences, and/or other parameters to determine to which vendor to direct the user. In some embodiments, the computer server can query each vendor (e.g., a vendor server or service) from the group of vendors for pricing, availability, and/or other information related to tickets to the concert in response to a message from a user indicating which item the user has selected, and determine to which vendor to direct the user based on this information. In other words, the computer server can access parameters of or information related to the group of vendors in real-time (e.g., the information is accessed at a computer server after the information has been requested). In some embodiments, the computer server can access information at a database and real-time information to determine to which vendor the user should be directed.

After the computer server has determined to which vendor the user should be directed, the computer server can direct the user to that vendor. In one embodiment, the user interacts with the webpage including the image, the computer server, and a vendor server hosting or providing access to a website via an Internet browser. The browser can request a webpage from the computer server in response to the user selecting the image. The computer server can determine a URL of a webpage provided by the vendor with the lowest priced tickets to a concert related to the image selected by the user, and can directly link the user to that vendor. In some embodiments, the computer server can send a redirect message such as, for example, a URL redirect command to the browser. The redirect message can include the URL of the webpage provided by the vendor with the lowest priced tickets, and the browser can access that webpage in response to the redirect message. In some embodiments, the webpage to which the user is directed can be referred to as a vendor purchase page. In some embodiments, the computer server can dynamically generate a webpage including two HTML frames and send that webpage to the browser. One of the frames can display the webpage of the vendor with the lowest priced tickets, and another frame can include references or links to webpages related to additional concerts or other vendors. Thus, the user can be directly linked (or directed) to the URL of the webpage provided by the vendor with the lowest priced tickets via a redirect message, a frame within a webpage, a new browser window or browser tab, or some other direct link provided by the computer server. After the user (or the user's browser) has been directed to the webpage of a vendor, the user can interact with that webpage to purchase tickets to the concert.

As used in this specification, the singular forms “a,” “an” and “the” include plural referents unless the context clearly dictates otherwise. Thus, for example, the term “a computer server” is intended to mean a single computer server or a combination of computer servers, “an item” is intended to mean one or more items, or a combination thereof.

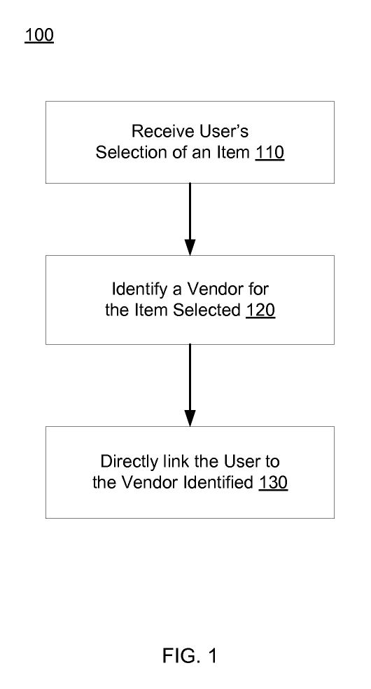

FIG. 1 is a flow chart of a method for directly linking a user to a vendor selling an item selected by the user, according to an embodiment. Process 100 can be implemented, for example, as a software module (e.g., source code, object code, one or more scripts, or instructions) stored at a memory and operable to be executed and/or interpreted or compiled at a processor operatively coupled to the memory at a computing device. For example, processor-executable instructions stored at a memory of a computing device can be executed at a processor at the computing device to cause the processor to execute the steps of process 100. In some embodiments, process 100 can be implemented as one or more hardware modules such as, for example, an application-specific integrated circuit (“ASIC”), a field-programmable gate array (“FPGA”), a processor, or other hardware module at a computing device. In some embodiments, process 100 can be implemented as a combination of one or more hardware modules and software modules at a computing device.

As illustrated in FIG. 1, a user's selection of an item is received, at 110. For example, a computer server (or link server) can receive a message including an indication of the user's selection of the item via a communications network. An indication of a selection of an item can be, for example, an argument or parameter in a URL or a message sent from a client terminal to a computer server that identifies the item. In response to receiving the selection, at 110, a vendor selling the item can be identified from a group of vendors selling the item, at 120. In some embodiments, vendors can be ranked according to various criteria including, for example, price of the item (e.g., face value price, price above face value, average price or average price above face value), availability of the item (e.g., availability of specific seating locations), a conversion rate (e.g., a rate at which users purchase the item from a vendor), a commission rate for referring or directing a user to a vendor, an approval rating, and/or other criteria and/or parameters. In some embodiments, the criteria or parameters can be accessed at a database. In some embodiments, the criteria or parameters can be accessed in real-time (e.g., in response to the user's selection of the item being received at 110) from one or more vendor servers. For example, a link server can query vendor servers to access criteria and/or parameters associated with vendors in response to a user's selection of an item. In some embodiments, some of the criteria or parameters can be accessed from a database and some of the criteria or parameters can be accessed in real-time from one or more vendor servers.

After a vendor from a group of vendors is identified or selected, at 120, the user can be directly linked (or directed) to the identified vendor, at 130. For example, a browser at a client terminal such as a personal computer, a notebook or laptop computer, a mobile computing device (e.g., a smartphone, a personal digital assistant (“PDA”) or a tablet computing device), or some other computing device operated by the user can be redirected to a webpage of or associated with the vendor identified at 120. In some embodiments, a webpage of or associated with the vendor identified at 120 can be linked inline or framed within a webpage provided by a link server. In some embodiments, multiple webpages—each associated with a different vendor—can be framed within a webpage. The user can interact with the webpage(s) to which he or she is directly linked or directed to, for example, purchase the item or access additional information related to the item.

In other words, the user can select the item (or a representation such as an image of the item) and be provided with a webpage associated with an identified vendor without additional action (e.g., selecting a hyperlink at a webpage) by the user. Thus, identifying the vendor and directly linking can be transparent to the user such that the user selects the item and is provided with the vendor's webpage related to the item without identifying (or selecting) the vendor or selecting the vendor's webpage (e.g., by selecting a hyperlink associated with the vendor's webpage).

In some embodiments, process 100 can include more or fewer steps than illustrated in FIG. 1. For example, after the vendor is identified at 120, other vendors offering the item (i.e., vendors at which the item is available that were not identified or selected at 120) can be discarded or rejected. In some embodiments, some steps may occur in a different order, for example, to account for added steps, pre- or post-processing, etc.

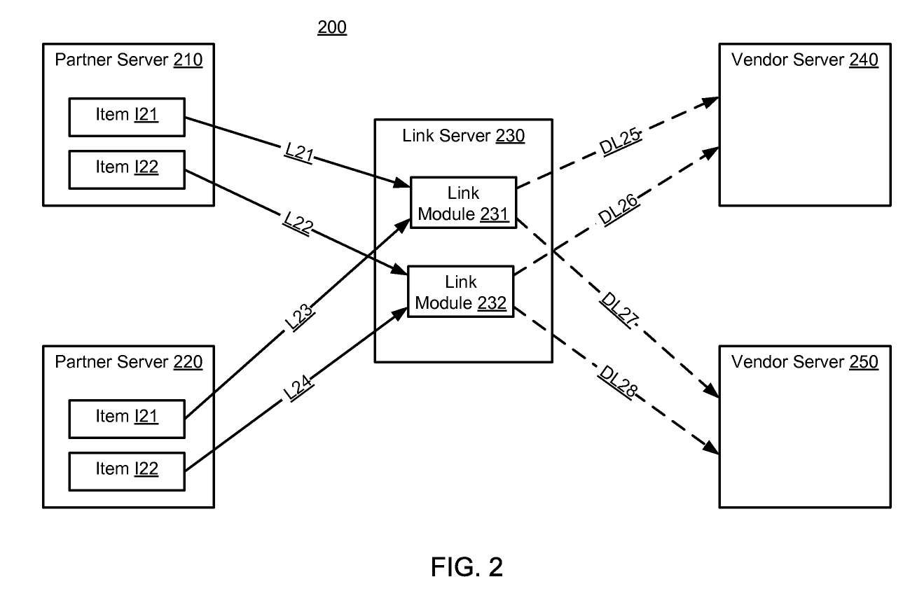

FIG. 2 is a block diagram of a system for directly linking a user to a vendor selling an item selected by the user, according to an embodiment. System 200 includes partner servers 210 and 220, link server 230, and vendor servers 240 and 250. Partner servers 210 and 220 can be, for example computer servers configured to provide access to or host webpages and/or websites that provide access to representations of items such as, for example, items for purchase. In some embodiments, partner servers 210 and 220 and link server 230 are operated by different entities. In some embodiments, at least one of partner servers 210 or 220 is operated by the same entity that operates link server 230. A representation of an item can include, for example, a textual description of an item, an image of an item, a virtual model (e.g., a three-dimensional rendering) of an item, and/or some other representation of an item. In other words, partner servers 210 and 220 can be web servers hosting webpages that reference other webpages (e.g., webpages at partner servers 210 and/or 220 or at other computer servers) via which items can be purchased by a user. In some embodiments, the webpages referenced by webpages hosted at partner servers 210 and 220 can include additional information about items represented at partner servers 210 and 220.

As illustrated in FIG. 2, partner servers 210 and 220 each include a representation of items I21 and I22. The representations of item I21 at partner servers 210 and 220 reference or are linked to link module 231 via links L21 and L23, respectively. Similarly, the representations of item I22 at partner servers 210 and 220 reference or are linked to link module 231 via links L22 and L24, respectively. Link modules 231 and 232 can be hardware and/or software modules at link server 230 (or accessible via link server 230), and are configured to determine to which vendor server to direct (or link) a user that has selected one of the representations of, for example, item I21.

Link module 231 references or links to vendor server 240 via dynamic link DL25. Link module 231 references or links to vendor server 250 via dynamic link DL27. Link module 232 references or links to vendor server 240 via dynamic link DL26. Link module 232 references or links to vendor server 250 via dynamic link DL28. Dynamic links DL25, DL26, DL27 and DL28 are referred to as dynamic links because the vendor server to which link modules 231 and 232 link (or to which link modules 231 and 232 direct a user) can change. For example, a first user can select the representation of item I21 at partner server 210, and link module 231 can determine that vendor server 240 is a best match (e.g., based on a vendor preference of partner server 210) and direct the first user to vendor server 240. A second user can select the representation of item I21 at partner server 220, and link module 231 can determine that vendor server 250 is a best match (e.g., based on a price comparison of item I21) and direct the second user to vendor server 250.

Link modules can determine best matches (e.g., to which vendor server to link or direct a user in relation to an item) based on a number of criteria, factors, and/or parameters. In some embodiments, a process for determining a best match can be referred to as ranking the vendors and the highest ranked vendor can be selected and the user directed to that vendor. The ranking can include combining and/or assigning weights (e.g., multiplicative factors) to criteria, factors, and/or parameters that are stored at a database or accessible to a link server at a vendor server and/or partner server.

Ranking the vendors can include, for example, ranking the vendors based on a set of factors (or ranking factors). The factors can include at least two of a conversion rate, a commission rate, an item availability, a vendors' reputation, a price, an average purchase price, purchase options, one or more delivery options, a partner influence, one or more historical analyses, a purchase medium, one or more service charges, one or more promotional codes, a time remaining, a presale, and/or a predetermined value.

A conversion rate can be a ratio of visitors to a vendor who convert to a sale to visitors who do not convert to a sale. This number can be influenced by other factors listed herein, as well as historical analyses. A commission rate can be a rate of income paid from the vendor to the content aggregating websites for generating a sale. For example, Vendor A may pay a $1 commission rate on a single sale of $100. Thus, Vendor A has a 1% commission rate.

Item availability can be a measure of whether or not an item at a certain price is in inventory and available for purchase by the user. Reputation can account for at least one of the vendor's brand name, reputation, appearance, customer satisfaction, and reviews. Price can be the cost of an item to an end user (or consumer), a wholesale cost and/or some other cost. In some embodiments, price can include additional costs such as a shipping cost, a handling cost, and/or an insurance cost. An average purchase (or average purchase price) can be an average price of an item from a vendor.

Purchase options can include payment methods accepted by the vendor. In some embodiments, more or better (e.g., faster or more economical) payment methods can provide a better score or increase a vendor's ranking. Payment methods can include, for example, credit cards, cashier's check, or cash. Delivery options can be the delivery methods available to the user from a vendor. Delivery methods can include, for example, paperless delivery, online delivery, will-call, or mail. Purchase medium can be a compatibility score or ranking between the payment options and the user's medium for purchasing. For example, mobile payment options may be given more weight when the user is purchasing the item via a mobile device. Service charges can be additional fees associated with a purchase (e.g., shipping, handling or processing).

Partner influence can be an influence or preference given to the ranking of a vendor by one or more affiliate partner websites. For example, a partner operating a partner server or website may prefer to work with Vendor A which would alter the partner influence factor. Historical analyses include a vendor's sales performance over a period of time.

Promotional codes can include any discounts and/or coupons provided to the user from the vendor. Time remaining can be the time period remaining until the item is no longer available. For example, the time remaining for a ticket to an event may change according to the proximity to the day of the event. This factor affects the likelihood of a sale. In another embodiment, a vendor with mail-only delivery options may be a less preferred vendor from which to buy tickets to an event on the day of the event.

Presale can be the availability of purchasing an item before the general public. For example, a vendor may offer for sale an early-access ticket to an event. Predetermined value can be a value pre-assigned to each vendor which bypasses all other factors, such that the vendors are ranked according to the predetermined values. For example, a number of vendors can each have a single factor with a predetermined or pre-assigned value, and the vendors can be ranked based solely on the single factor (i.e., on the pre-assigned value of the single factor of each vendor). In some embodiments, the single factor can be weighted differently than other factors.

Additionally, other factors can be included. For example, ticket location and/or a number of available tickets in a particular section or location can be a factor. Type of seating (e.g., covered, padded, etc.) can also be a factor.

For example, the following table shows the algorithm associated with the three vendors, Vendor A, Vendor B, and Vendor C, identified for Item Z.

TABLE 1
Ranking algorithm for Item Z.

| | | | |
|---|---|---|---|
| Maximum | | | |
| Value | Value | Weight | Weighted Value |

Vendor A

| | | | | |
|---|---|---|---|---|
| Commission Rate | 1 | 0.01 | 10 | 0.1 |
| Conversion Rate | 1 | 0.04 | 20 | 0.8 |
| Ticket Availability | 1 | 1 | 50 | 50 |
| Reputation | 10 | 8 | 10 | 8 |
| Total Weighted Sum | | | | 58.9 |

Vendor B

| | | | | |
|---|---|---|---|---|
| Commission Rate | 1 | 0.1 | 10 | 1.0 |
| Conversion Rate | 1 | 0.01 | 20 | 0.2 |
| Ticket Availability | 1 | 0 | 50 | 0 |
| Reputation | 10 | 6 | 10 | 6 |
| Total Weighted Sum | | | | 7.2 |

Vendor C

| | | | | |
|---|---|---|---|---|
| Commission Rate | 1 | 0.08 | 10 | 0.8 |
| Conversion Rate | 1 | 0.04 | 20 | 0.8 |
| Ticket Availability | 1 | 1 | 50 | 50 |
| Reputation | 10 | 9 | 10 | 9 |
| Total Weighted Sum | | | | 60.6 |

In this embodiment, three vendors are selected for Item Z. Four factors are identified for these three vendors: commission rate, conversion rate, ticket availability, and reputation. The set of four factors is the same for each vendor. Each factor has a range of values, zero being the minimum and the maximum being identified in the column labeled “Maximum Value.” The range of values are the same for each vendor. For example, the range of values for the commission rate for all three vendors are 0 to 1. Each factor is given a value for that vendor. For example, the value given to Vendor A for commission rate is 0.01. Each factor is assigned a weight, such that the weight associated with a factor is the same for each vendor. For example, the weight associated with the commission rate for all three vendors is 10. Each value is multiplied by each weight to obtain the weighted value for that factor for that vendor. For example, the weighted value for the commission rate of Vendor A is the value, 0.01, multiplied by the weight, 10, to obtain the weighted value of 0.1. In some embodiments, as illustrated in the factor “Reputation” of Table 1, the value of a factor is first divided by the maximum value for that factor before the value is multiplied by the weight. In other words, a weighted value for each factor can be determined as follows:

$$WV = \frac{V}{MV} \times W ;$$

where WV is the weighted value, V is the value, MV is the maximum value, and W is the weight.
Finally, the weighted value for each factor is summed to obtain the total weighted sum of each vendor. The vendors are then ordered according to their rank. The table below provides the ranking of Vendor A, Vendor B, and Vendor C associated with Item Z.

TABLE 2
Ranking for Item Z.

| Vendor | Total Weighted Sum |
|---|---|
| Vendor C | 60.6 |
| Vendor A | 58.9 |
| Vendor B | 7.2 |

According to this embodiment, Vendor C would be identified as the highest ranking vendor. In another embodiment, Vendor A may be identified as the second highest ranking vendor. Other embodiments include ranking the vendors according to the predetermined values or ranking the vendors based on any combination of at least three factors. After Vendor C is identified, the website displays Vendor C's webpage to the user. The vendor's webpage is a webpage at which the content displayed is controlled by the vendor.

As discussed above, the best match vendor is the vendor with the highest weighted sum. In some embodiments, the best match vendor can be the vendor with the lowest weighted sum.

In some embodiments, the capacity of the venue and the size of the particular event are factors that are used to determine which vendor is the best match. For example, the primary prices can be used to determine the size of the desired event, which can then be used to gauge the availability of tickets. The price over face value for a ticket to the event and/or the number of days until the event can also be used to gauge the availability of tickets.

Specifically, in one example, the size of an event can be based on the average primary ticket price and/or the number of secondary tickets available (e.g., if no primary ticketing data). The availability of tickets for an event can be determined, for example, using the primary availability data, the number of secondary tickets available, the average secondary ticket price percentage above average primary ticket price, and/or time (e.g., days) until the event. In some cases, the limits can vary based on the event size.

If there is limited availability to the event (e.g. the event is sold out), the highest ranking secondary seller available is chosen (e.g., based on price, ticket availability, commission, conversion rate, reputation, etc). If availability is not limited, the highest ranking primary seller available is chosen (e.g., based on price, ticket availability, commission, conversion rate, reputation, etc)

Additionally, various combinations of factors can be included in calculating a total weighted sum. For example, five of ten factors can be included in a total weighted sum. Ten of ten factors can be included in a total weighted sum. A single factor can be included in a total weighted sum. Furthermore, in some embodiments, vendor rankings can be statically assigned. In other words, a total weighted sum can be assigned rather than calculated and the vendor with the highest assigned ranking will be selected as the best match vendor.

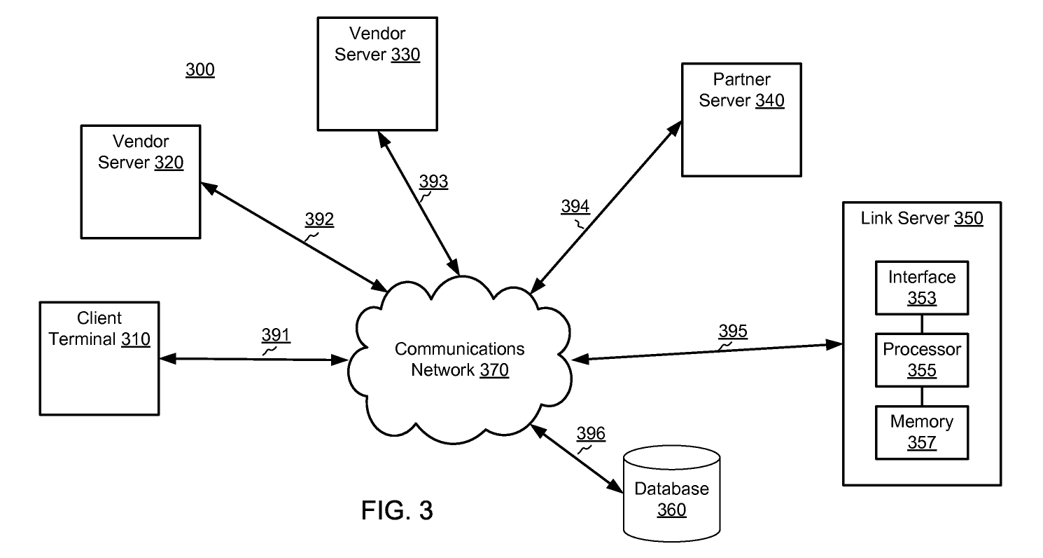

FIG. 3 is a system block diagram of a system for locating an item for purchase via a communications network, according to an embodiment. System 300 includes client terminal 310, vendor server 320, vendor server 330, partner server 340, link server 350, and database 360. Client terminal 310, vendor server 320, vendor server 330, partner server 340, link server 350, and database 360 are operatively coupled to communications network 370 via network connections 391, 392, 393, 394, 395 and 396, respectively. In some embodiments, database 360 can be directly coupled to link server 350 or operatively coupled to link server 350 via a communications network separate from communications network 370 such as a local area network (“LAN”).

Communications network 370 can be any communications network configurable to allow client terminal 310, vendor server 320, vendor server 330, partner server 340, link server 350, and database 360 to communicate with communications network 370 and/or to each other through communications network 370. Communications network 370 can be any network or combination of networks capable of transmitting information (e.g., data and/or signals) and include, for example, a telephone network, an Ethernet network, a fiber-optic network, a wireless network, and/or a cellular network.

In some embodiments, communications network 370 can include multiple networks operatively coupled to one another by, for example, network bridges, routers, switches and/or gateways. For example, client terminal 310 can be operatively coupled to a cellular network and link server 350 can be operatively coupled to a fiber-optic network. The cellular network and fiber-optic network can each be operatively coupled to one another via one or more network bridges, routers, switches, and/or gateways such that the cellular network, the Ethernet network and the fiber-optic network are operatively coupled to form a communications network. Alternatively, the cellular network and fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communications network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection.

In some embodiments, a system can include more than one client terminal, more than one partner server, more than one link server, and/or more than one database. Thus, for example, a client terminal can access multiple partner servers and a link server can direct more than one client terminal to vendor servers. In some embodiments, a first client terminal, a second client terminal and/or a link server can be operatively coupled to a communications network by heterogeneous network connections. For example, a client terminal can be operatively coupled to the communications network by a WWAN network connection, another client terminal can be operatively coupled to the communications network by a DSL network connection, and a link server can be operatively coupled to the communications network by a fiber-optic network connection.

As illustrated in FIG. 3, link server 350 includes processor 355, interface 353 and memory 357. Link server 350 is operatively coupled to communications network 370 via interface 353 and network connection 395. Interface 353 can be any interface configurable to be operatively coupled to communications network 370 via network connection 395. For example, an interface can be a wireless interface such as, for example, a worldwide interoperability for microwave access (“WiMAX”) interface, a high-speed packet access (“HSPA”) interface, and/or a WLAN interface. An interface can also be, for example, an Ethernet interface, a broadband interface, a fiber-optic interface, and/or a telephony interface.

Processor 355 is operatively coupled to interface 353 such that processor 355 can be configured to be in communication with communications network 370 via interface 353. Processor 355 can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages as Java™, C++, C, assembly, a hardware description language, or any other suitable programming language. A processor according to some embodiments includes media and computer code (also can be referred to as code) specially designed and constructed for the specific purpose or purposes.

In some embodiments, a processor can be, for example, a single physical processor such as a general-purpose processor, an ASIC, a PLD, or a FPGA having a single processing core or a group of processing cores. In some embodiments, a processor can be a group or cluster of processors such as a group of physical processors operatively coupled to a shared clock or synchronization signal, a shared memory, a shared memory bus, and/or a shared data bus. In other words, a processor can be a group of processors in a multi-processor computing device. In some embodiments, a processor can be a group of distributed processors (e.g., computing devices with one or more physical processors) operatively coupled one to another via a communications network. Said differently, a processor can be a group of distributed processors in communication one with another via a communications network. In some embodiments, a processor can be a combination of such processors. For example, a processor can be a group of distributed computing devices, where each computing device includes a group of physical processors sharing a memory bus and each physical processor includes a group of processing cores.

In some embodiments, a server (or processor) can be a virtual device implemented in software such as, for example, a virtual machine executing on or in a processor. For example, a server can be a software module executing in a virtual machine environment such as, for example, a Java™ module executing in a Java™ Virtual Machine (“JVM”), or an operating system executing in a VMware™ virtual machine. In some such embodiments, a network interface, a processor, and a memory can be virtualized and implemented in software executing in, or as part of, a virtual machine.

Processor 355 is also operatively coupled to memory 357. Memory 357 can be a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

In addition to memory 357, some embodiments include another processor-readable medium, for example a database such as database 360 accessible to link server 350, having instructions or computer code thereon for performing various processor-implemented operations including, for example, signing and verifying digital documents. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks; solid-state memory such as SSDs and FLASH memory; and ROM and RAM devices. Examples of computer code include, but are not limited to, micro-code or micro-instructions, machine instructions (such as produced by a compiler), and files containing higher-level instructions that are executed by a computer using an interpreter. For example, an embodiment may be implemented using Java™, C++, or other object-oriented programming language and development tools. Additional examples of computer code include, but are not limited to, control signals, encrypted code, and compressed code.

In some embodiments, client terminal 310, vendor server 320, vendor server 330, partner server 340, link server 350, and database 360 also each include an interface, a processor and a memory. For example, a personal computer terminal and a portable or handheld device, such as a cellular telephone device or portable/mobile internet device, can include an interface, a processor and a memory.

Referring to FIG. 3, in some embodiments, partner server 340 can host a website including a webpage including an item (or a representation of an item) available for purchase from a vendor associated with vendor server 320 and/or a vendor associated with vendor server 330, client terminal 310 includes a browser, and link server 350 provides an interface such as an HTTP interface (or a web server). A user of client terminal 310 can navigate to the webpage hosted at partner server 340 that displays the item for sale. Partner server 340 can host, for example, a website that displays information about music and musicians. An item for sale can be, for example, a good or a service. Each displayed item (or displayed representation of an item) can be related to a reference (or link or URL) for that item. In some embodiments, an item and/or link associated with a specific concert at a specific venue for a specific musician is displayed. Thus, the items can be related to mutually exclusive items. Said differently, the items (and related links) can be associated with mutually exclusive items. After the user selects an item for sale, the user is directed (i.e., transparently linked or redirected) to a resource (such as a link module) at resource 350 that is related to that item.

Link server 350 can determine a best match vendor, and direct the user to a webpage hosted at (or available via) the vendor server from vendor servers 320 and 330 that is associated with the best match vendor. In some embodiments, link server 350 can access ranking factors stored at database 360 (e.g., stored by partner server 340, vender server 320, vendor server 330, and/or link server 350) to determine a best match vendor. In some embodiments, link server 350 can request or query ranking factors from partner server 340, vender server 320, and/or vendor server 330 in real-time using, for example, one or more application programming interfaces (“APIs”) provided at partner server 340, vender server 320, and/or vendor server 330.

In some embodiments, link server 350 continuously aggregates items for sale, their vendors, and/or ranking factors (e.g., by querying partner server 340, vender server 320, and/or vendor server 330) and stores information related to items for sale, their vendors, and/or ranking factors at database 360. In other words, database 360 can be updated periodically or continuously, such that database 360 reflects changes to the vendors or items in response to (e.g., at the time of) receipt of a user's selection. For example, if a vendor sold out of tickets to an event, link server 350 can receive information related to the quantity of available tickets from vender server 320 and/or vendor server 330, and can update database 360 to account for the unavailability of purchasing tickets from that vendor. In another embodiment, if an event or availability of an item is cancelled, link server 350 can update database 360 to account for the cancellation of the event and the unavailability of purchasing a ticket to the event. In some embodiments, a vendor such as one associated with vendor server 320 can push updated information related to items for sale, vendors, and/or ranking factors to database 360.

After a best match vendor is identified, the user can be directed to the vendor server from vendor servers 320 and 330 associated with that vendor and hosting a webpage providing an interface for purchasing the item. For example, link server 350 can provide a reference (e.g., a URL or link) to a vendor's webpage at vendor server 320 and a redirect message to client terminal 310 (e.g., a browser or other application running at client terminal 310) such that client terminal 310 can display the vendor's webpage. A vendor's webpage is a webpage with content that is controlled by the vendor selling the item. The content includes, in some embodiments, purchase information for the item selected. For example, a vendor's webpage displayed can be a webpage controlled by a ticket-seller allowing a user to purchase a ticket to a specific concert. A redirect message can be any signal, command, instruction or other message that directs a client terminal (e.g., a client terminal running a browser) to access a webpage identified by a reference such as a URL. In some embodiments, a redirect message can include a reference to webpage or other resource available via a communications network.

In some embodiments, identifying a best match vendor and directing a user to that vendor's website (or a webpage associated with that vendor) is transparent to the user. In other words, the best match vendor can be identified and the user can be directed to that vendor's website such that the user, from the user's perspective, appears to be directed to the vendor's website without any additional user action. For example, a user can select a representation of an item by clicking on the representation of the item within a browser and a vendor's webpage is displayed at a the browser without additional action by the user. That is, the user is not presented with a number of options (e.g., hyperlinks) related to multiple vendors from which the item can be acquired. Rather, the user is directed (or directly linked) to a webpage of the vendor that is selected as the best match vendor without additional user intervention.

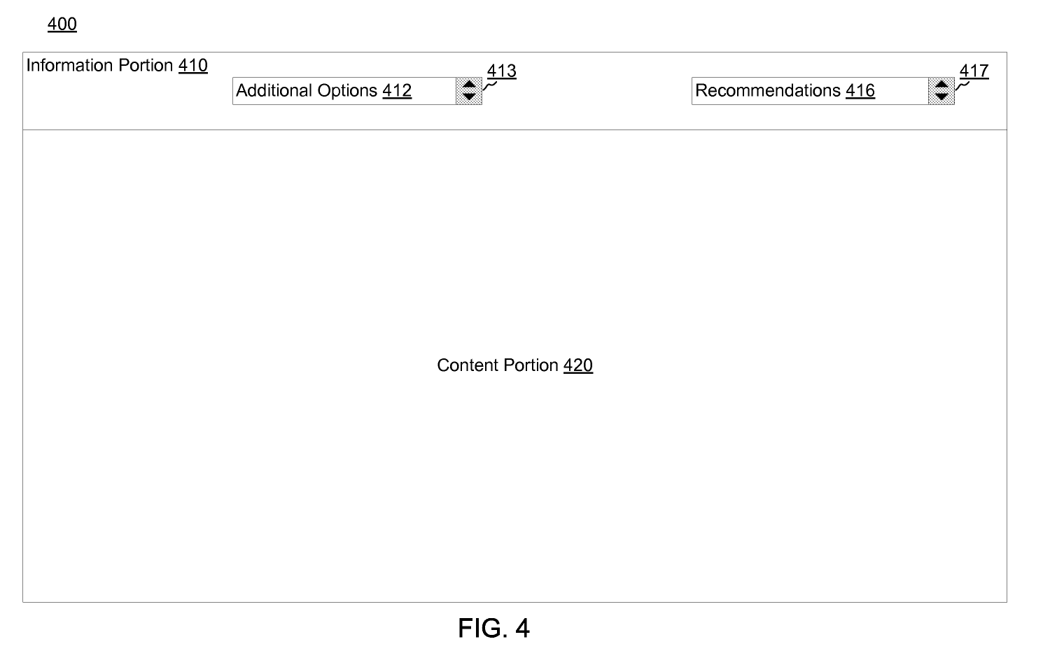

In some embodiments, an interface for selecting a different vendor and/or a different or additional item can be provided in addition to directing the user to the vendor's webpage. For example, FIG. 4 is a block illustration of a webpage displaying an item for sale, according to an embodiment. Webpage 400 includes information portion 410 and content portion 420. Information portion 410 includes an interface for selecting additional options 412 and an interface for selecting recommended items 416. For example, as illustrated in FIG. 4, interface for selecting additional options 412 is a drop-down menu controlled by drop-down control 413. A user can select drop-down control 413 to view a list of options related to an item such as, for example, additional vendors at which the item is available. For example, vendors that were not the best match vendor (e.g., had lower rankings than the best match vendor) can be displayed. Said differently, a link server (or other server) can send a reference associated with one or more vendors in addition to the best match vendor. For example, a reference to a second best match vendor and a reference to a third best match vendor can be sent to a client terminal, and a reference to a fourth best match vendor can not be sent to the client terminal. Content portion 420 of webpage 400 can display a webpage associated with the best match vendor, and drop-down control 413 can display the reference to an additional vendor at which the item is available. In some embodiments, a reference to one or more vendors can be a numeric or other code identifier, and a title, a name, or some other description of the one or more vendors can be displayed at drop-down control 413. Thus, a numeric code can be used as a reference to a vendor (or information related to the vendor) by a link server, and a description of the vendor can be displayed at drop-down control 413 to a user. In some embodiments, additional options such as, for example, delivery options and/or other options can be displayed.

Similarly, interface for selecting recommended items 416 is a drop-down menu controlled by drop-down control 417. A user can select drop-down control 417 to view a list of other items that are recommended for purchase, for example, based on the item. Interface for selecting additional options 412 and interface for selecting recommended items 416 can be populated (e.g., data or information can be inserted) by a link server such as link server 350 discussed in relation to FIG. 3. In other words, link server 350 can provide additional options and/or recommendations for additional items to a user via webpage 400. For example, tickets to a different concert at the same venue or a nearby venue can be displayed. Additionally, tickets to the same or similar band or concert at a different venue can also be displayed as recommendations.

Content portion 420 can be, for example, a frame within webpage 400 configured to display a vendor webpage including vendor content. In other words, a vendor webpage can be framed within a webpage provided by a link server. Said differently, a user can be directly linked to a vendor webpage via a frame in a webpage or a partner server. As discussed above, the vendor webpage that is made accessible within (e.g., is displayed at) content portion 420 can be a best match vendor. Thus, the user can be directly linked (or directed) to a vendor rather than requiring a user to select a vendor from a list of vendors.

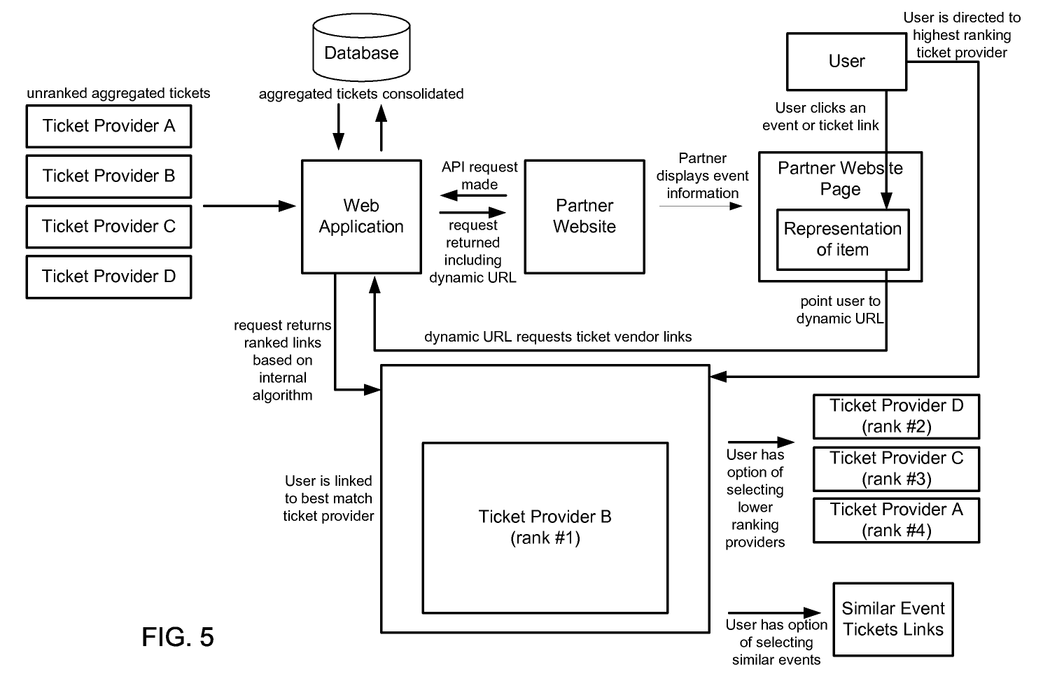

FIG. 5 is a schematic block diagram of a system for directly linking a user to a vendor selling an item selected by the user including message flows, according to an embodiment. As illustrated in FIG. 5, the ticket providers (e.g., vendors) and the partner website can communicate with a web application hosted at, for example, a link server to link a user to a best match vendor. The web application can aggregate tickets to one or more events at a database and provide an API to the partner website to provide dynamic URLs to a user (via the partner website and the partner website page).

Additionally, the web application can provide the user with access to a webpage including content from the best match ticket provider (Ticket Provider B in FIG. 5). Additionally, the web application can provide the user with an option (via a webpage) to select a different (e.g., lower-ranked ticket provider) and/or a similar event to which the user can purchase tickets.

In one embodiment, a computer-implemented method includes receiving a user's selection of an item, identifying a vendor for the item selected after the receiving, and displaying the vendor's purchase page for the item in response to the user's selection. The receiving can include displaying at least one item for sale on a partner website. The identifying can include identifying a group of vendors for the item selected and selecting a vendor from the group. The identifying can include identifying at least one vendor for the item selected after the receiving and, if more than one vendor is identified, ranking the vendors. The identifying can also include identifying a group of vendors for the item selected, ranking the vendors, and selecting a preferred vendor based on the ranking. In some embodiments, the identifying includes ordering a group of vendors according to pre-assigned values given to the vendors and selecting a vendor.

In some embodiments, the computer-implemented method includes displaying an interface in response to the user's selection, the interface being configured to provide a list of other selections. The selections can include at least one of the vendors identified in response to the user's selection. The selections can include at least one of the vendors identified in response to the user's selection, the selections being displayed in order of their rank. The selections can include vendors or items for sale. In some embodiments, the selections can be configured to be manually selected by a user. In some embodiments, the computer-implemented method includes displaying on the interface at least one vendor identified in response to the user's selection of the item, receiving the user's manual selection of the vendor, and displaying the vendor's purchase page in response to the user's manual selection.

In one embodiment, a computer-implemented method of ranking vendors for an item selected by a user includes identifying vendors selling the item selected and ranking the vendors based on at least two of a conversion rate, a commission rate, an item availability, a reputation, a price, an average purchase, a purchase options, a delivery options, a partner influence, a historical analyses, a purchase medium, a service charges, a promotional codes, a time remaining, a presale, and/or a predetermined value. The identifying can include identifying vendors in response to a user's selection of the item.

In some embodiments, the computer-implemented method of ranking vendors for an item selected by a user assigning each factor a value on a scale of values assigned to each factor, assigning each factor a weight, multiplying the weight of a factor by its associated value to obtain a weighted value for the factor, summing the weighted values of each factor for a vendor, and ordering the vendors by the total sum of the weighted values for each vendor. In some embodiments, the factors include at least conversion rate and commission rate, and at least one of item availability, reputation, price, average purchase, purchase options, delivery options, partner influence, historical analyses, purchase medium, service charges, promotional codes, time remaining, presale, and/or predetermined value.

In one embodiment, a computer-implemented method includes receiving a user's selection of an item, identifying vendors that sell the item selected after the receiving, selecting a vendor based on a set of factors, and displaying the vendor's purchase page in response to the user's selection. The receiving can include displaying at least one item for sale on a partner website. The receiving can include receiving the user's selection of a concert listing on a partner website. The identifying can include identifying a group of vendors selling tickets to the concert listing selected by the user. The selecting can include ranking the vendors based on the set of factors and selecting a preferred vendor from the ranking. The selecting can include ranking the vendors based on the commission rate, conversion rate, ticket availability, and reputation and selecting the vendor with the highest ranking.

In some embodiments, the computer-implemented method includes displaying an interface on the vendor's purchase page providing at least one other vendor identified in response to the user's selection. The displaying can include providing the vendor's webpage to the user, the webpage content being controlled by the vendor, the webpage allowing the user to purchase the item from the vendor. In some embodiments, the computer-implemented method includes identifying factors to use in ranking the vendors, the factors including at least the commission rate and the conversion rate, assigning a value to each factor of each vendor among a range of values for each factor, assigning a weight to each factor of each vendor, multiplying the value of each factor of each vendor by its associated weight to obtain a weighted value for each factor of each vendor, summing the weighted values of each factor of each vendor to obtain the total weighted sum of each vendor, ordering the vendors by their total weighted sums, and selecting the vendor with the largest total weighted sum.

While certain embodiments have been shown and described above, various changes in form and details may be made. For example, some features of embodiments that have been described in relation to one embodiment and/or process for directing a user to a vendor server can be useful in other embodiments and/or processes. Additionally, some embodiments that have been described in relation to a software implementation can be implemented as digital or analog hardware. Furthermore, it should be understood that the systems and methods described herein can include various combinations and/or sub-combinations of the components and/or features of the different embodiments described. For example, elements described as servers or computer servers can be virtual servers such as virtualized computer servers hosted at a common physical computer server. Thus, features described with reference to one or more embodiments can be combined with other embodiments described herein.

1. A method, comprising:
receiving from a client terminal an indication of a selection of an item;
selecting a vendor from a plurality of vendors in response to the receiving, each vendor from the plurality of vendors offering the item for sale; and
sending a redirect message to the client terminal, the redirect message including a reference to a webpage associated with the vendor and the item.

2. The method of claim 1, wherein the webpage is displayed at the client terminal in response to the redirect message.

3. The method of claim 1, wherein at least two factors are associated with each vendor from the plurality of vendors, the method further comprising:
ranking, before the selecting, the plurality of vendors based on the at least two factors associated with each vendor from the plurality of vendors, the selecting being based on the ranking.

4. The method of claim 1, further comprising:
accessing at a first server a first plurality of factors associated with a first vendor from the plurality of vendors;
accessing at a second server a second plurality of factors associated with a second vendor from the plurality of vendors; and
ranking, before the selecting, the first vendor from the plurality of vendors and the second vendor from the plurality of vendors based on the first plurality of factors and the second plurality of factors, the selecting being based on the ranking.

5. The method of claim 1, further comprising:
accessing at a database a first plurality of factors associated with a first vendor from the plurality of vendors;
accessing at the database a second plurality of factors associated with a second vendor from the plurality of vendors; and
ranking, before the selecting, the first vendor from the plurality of vendors and the second vendor from the plurality of vendors based on the first plurality of factors and the second plurality of factors, the selecting being based on the ranking.

6. The method of claim 1, wherein the vendor is a first vendor, the method further comprising:
accessing a first plurality of factors associated with the first vendor from the plurality of vendors;
accessing a second plurality of factors associated with a second vendor from the plurality of vendors; and
ranking, before the selecting, the first vendor from the plurality of vendors and the second vendor from the plurality of vendors based on a single factor from the first plurality of factors and a single factor from the second plurality of factors, the selecting being based on the ranking,
the single factor from the first plurality of factors having a first pre-assigned value,
the single factor from the second plurality of factors having a second pre-assigned value.

7. The method of claim 1, wherein the vendor is a first vendor, the method further comprising:
selecting, in response to the receiving, a second vendor from a plurality of vendors, the plurality of vendors including the first vendor, the second vendor, and a third vendor; and
sending a reference associated with the second vendor to the client terminal.

8. The method of claim 1, wherein the vendor is a first vendor, the method further comprising:
selecting, in response to the receiving, a second vendor from a plurality of vendors, the plurality of vendors including the first vendor, the second vendor, and a third vendor;
sending a reference associated with the second vendor to the client terminal; and
not sending a reference associated with the third vendor to the client terminal.

9. The method of claim 1, wherein the vendor is a first vendor and the webpage is a first webpage, the method further comprising:
selecting, in response to the receiving, a second vendor from a plurality of vendors, the plurality of vendors including the first vendor, the second vendor, and a third vendor;
sending a reference associated with the second vendor to the client terminal;
receiving from the client terminal an indication of a selection of the second vendor; and
sending a redirect message to the client terminal, the redirect message including a reference to a second webpage associated with the second vendor and the item.

10. The method of claim 1, further comprising ranking, before the selecting, the plurality of vendors based on at least two of a conversion rate, a commission rate, an item availability, a reputation, a price, an average purchase, a purchase option, a delivery option, a partner influence, a historical analysis, a purchase medium, a service charge, a promotional code, a time remaining, or a presale, the selecting being based on the ranking.

11. A computer-implemented method, comprising:
receiving an indication of a selection of an item;
identifying a plurality of vendors, each vendor from the plurality of vendors offering the item for sale;
accessing a plurality of rankings, each ranking from the plurality of rankings uniquely associated with a vendor from the plurality of vendors;
selecting a single vendor from the plurality of vendors based on the ranking associated with the single vendor from the plurality of rankings; and
sending a reference to a webpage associated with the single vendor and the item to a client terminal.

12. The method of claim 1, further comprising sending a redirect message to the client terminal, the webpage being displayed at the client terminal in response to the redirect message.

13. The method of claim 11, further comprising defining, before the accessing, the plurality of rankings based on at least two factors associated with each vendor from the plurality of vendors.

14. The method of claim 11, further comprising
selecting a plurality of factors, each vendor from the plurality of vendors having a factor value associated with each factor from the plurality of factors;
assigning a weight value to each factor from the plurality of factors;
multiplying the weight value for each factor from the plurality of factors by the factor value associated with that factor of each vendor from the plurality of values to define a weighted value for each factor from the plurality of factors for each vendor from the plurality of vendors;
summing the weighted values for each factor from the plurality of factors for each vendor from the plurality of vendors to define a total sum value for each vendor from the plurality of vendors; and
defining the plurality of rankings based on the total sum value for each vendor from the plurality of vendors, the selecting being based on the ranking.

15. The method of claim 11, further comprising sending a redirect message to the client terminal such that the client terminal accesses the webpage associated with the single vendor and the item.

16. A processor-readable medium storing code representing instructions that when executed by a processor cause the processor to:
receive from a client terminal an indication of a selection of an item;
identify a plurality of vendors in response to the receiving, each vendor from the plurality of vendors offering the item for sale;
select a vendor from the plurality of vendors in response to the receiving, each vendor from the plurality of vendors offering the item for sale; and
send a redirect message to the client terminal, the redirect message including a reference to a webpage associated with the vendor and the item.

17. The processor-readable medium of claim 16, wherein the vendor is a first vendor, the processor-readable medium further storing code representing instructions that when executed by a processor cause the processor to:
access a first plurality of factors associated with the first vendor from the plurality of vendors;
access a second plurality of factors associated with a second vendor from the plurality of vendors;
rank, before the selecting, the first vendor from the plurality of vendors and the second vendor from the plurality of vendors based on a single factor from the first plurality of factors and a single factor from the second plurality of factors, the selecting being based on the ranking,
the single factor from the first plurality of factors having a first pre-assigned value,
the single factor from the second plurality of factors having a second pre-assigned value.

18. The processor-readable medium of claim 16, wherein at least two factors are associated with each vendor from the plurality of vendors, the processor-readable medium further storing code representing instructions that when executed by a processor cause the processor to:
rank, before the selecting, the plurality of vendors based on the at least two factors associated with each vendor from the plurality of vendors, the selecting being based on the ranking.

19. The processor-readable medium of claim 16, wherein the vendor is a first vendor and the plurality of vendors includes the first vendor, a second vendor, and a third vendor, the processor-readable medium further storing code representing instructions that when executed by a processor cause the processor to:
discard the second vendor in response to the selecting the first vendor; and
discard the third vendor in response to the selecting the first vendor.

20. The processor-readable medium of claim 16, further storing code representing instructions that when executed by a processor cause the processor to:
access at a first server a first plurality of factors associated with a first vendor from the plurality of vendors;
access at a second server a second plurality of factors associated with a second vendor from the plurality of vendors; and
rank, before the selecting, the first vendor from the plurality of vendors and the second vendor from the plurality of vendors based on the first plurality of factors and the second plurality of factors, the selecting being based on the ranking.
